(19) United States
(12) Patent Application Publication
(10) Pub. No.: US 2025/0073701 A1
(43) Pub. Date: Mar. 6, 2025

(54) INTEGRATED VALVE BODY AND SYRINGE TUBE COMPONENT FOR ASSAY CARTRIDGES

(71) Applicant: Cepheid, Sunnyvale, CA (US)

(72) Inventors: Keith Herrington, Sunnyvale, CA (US); Douglas B. Dority, Mill Valley, CA (US); Abhishek Yellapragada, Sunnyvale, CA (US)

(21) Appl. No.: 18/818,327

(22) Filed: Aug. 28, 2024

Related U.S. Application Data
(60) Provisional application No. 63/579,463, filed on Aug. 29, 2023.

(51) Int. Cl. B01L 3/00

(52) U.S. Cl. CPC B01L 3/502; B01L 2200/0689; B01L 2200/12; B01L 2300/042; B01L 2300/0681; B01L 2300/12; B01L 2400/0475; B01L 2400/0644

(57) ABSTRACT

Integrated valve body and syringe tube components to facilitate controlled fluid flow in assay cartridges are provided herein. Such components can include a valve body and syringe tube that are integrally formed as a single component. Components can include a syringe tube having a conduit in fluid communication with a valve body having a filter cavity and set of ports to facilitate direct fluid flow between chambers and fluid flow through a filter in the filter cavity of the valve body. Valve body can include an off-center filter cavity and a direct flow path in fluid communication with a filter flow path disposed in a common plane and designed to inhibit cross-contamination between flow paths. Valve body can be sealed by a cap snap-fit or welded to the valve body or a thin film. Flow valves can also be included. Two-part welding stack improves control of filter compression and performance.

### CROSS-REFERENCES TO RELATED APPLICATIONS

This application is a Non-Provisional of and claims the benefit of priority of U.S. Provisional Application No. 63/579,463 filed Aug. 29, 2023, the entire contents of which are incorporated by reference herein by reference.

### FIELD OF ART

The present invention relates generally to the field of biochemical analysis devices, and in particular to rotatable valve body and syringe tube components for assay cartridges.

### BACKGROUND

The analysis of fluids such as clinical or environmental fluids for analytical testing generally involves a series of processing steps, which may include chemical, optical, electrical, mechanical, thermal, or acoustical processing of the fluid samples and subsequent analytical detection of one or more target analytes. Whether incorporated into a bench-top instrument, a disposable cartridge, or a combination of the two, such processing typically involves complex fluidic assemblies and processing algorithms.

Conventional systems for processing fluid samples can employ a sample cartridge, which employs a series of chambers each configured for subjecting the fluid sample to a specific processing step. The fluid sample is transported through the system sequentially from chamber to chamber by pressurized fluid flow, by which the fluid sample undergoes the processing steps according to a specific protocol. In some such systems, a sample processing device or cartridge can be operated according to any number of different protocols as required to prepare and test for a given target analyte. These different protocols may require differing buffers, reagent, primers, probes, lysis by chemical and/or mechanical means, as well as various thermal cycling processing. In some cartridges, the cartridges can include a filter, such as glass filter, configured for binding with nucleic acid released from the target by chemical lysing.

In recent years, there has been considerable development in the field of biological testing devices that facilitate manipulation of a fluid sample within a sample cartridge to prepare the sample for biological testing by polymerase chain reaction (PCR). One notable development in this field is the GeneXpert® sample cartridge by Cepheid. The configuration and operation of these types of cartridges typically involves manipulation of fluid between multiple chambers by a rotatable valve assembly, which can be further understood by referring to U.S. Pat. No. 6,374,684 entitled “Fluid Control and Processing System,” and U.S. Pat. No. 8,048,386 entitled “Fluid Processing and Control.” The fluid sample is transported through the system sequentially from chamber to chamber by pressurized fluid flow facilitated by actuation of a plunger through a syringe tube and through one or more flow channels of a rotatable valve body that is rotated to align the flow channels between particular chambers of the cartridge. The valve body can further include a filter, such as glass filter, configured for binding with nucleic acid released from the target by chemical lysing. While such sample processing cartridges represent a considerable advancement in the state of the art, there are certain challenges in regard to manufacturing, assembly, performance and use of such systems and processes. For example, the sample cartridge is a precision instrument requiring interaction between various components and sub-assemblies. Defects in any of these components or sub-assemblies can result in a defective cartridge and impact reliability of manufacturing processes, overall manufacturing and product reliability. Further, the cartridge includes a number of sub-assemblies, including a syringe tube and valve assembly and the flow paths through the valve assembly can be such that carryover or contamination can be a concern.

There is a need for sample cartridges that overcome various challenges noted above and allow for improved performance of operation of a sample cartridge in performing sample preparation and testing. There is further need for these sample cartridges to be compatible with existing technologies yet reduce cost and complexity of manufacturing and assembly.

### BRIEF SUMMARY

The present invention pertains to an integrated valve body and syringe tube (VBST), which improves ease of manufacture and assembly, and which can include one or more fluid flow features that improve performance. The integrated valve body and syringe tube can be formed as a single component, such as by injection molding. The valve body defines a filter cavity (i.e. filter pocket) and flow paths on an underside, sealed by a cap or a thin film, and optionally a gasket.

In a first variation, the integrated valve body and syringe tube includes a valve body with a center filter cavity for the filter. The valve assembly is sealed by a cap that is joined by a snap-fit interface or any suitable means. The valve assembly can include a gasket to provide additional sealing. The substrate can be formed of polypropylene or any suitable material. One advantage of this variation is that welding connections can be eliminated.

In a second variation, the integrated valve body and syringe tube includes a valve with a center filter cavity. The valve assembly is sealed by a cap that is joined by an ultrasonic shear weld or any suitable means. The valve assembly can include a gasket to provide additional sealing. The substrate can be formed of polypropylene, copolyester, polycarbonate, or any suitable material. The gasket can be formed of an elastomer or any suitable material. The shear weld joint in a two-part valve body assembly enables precise control of filter compression which allows better control of fluidics and relevant performance metrics such as filter capture, backpressure, and pressure aborts within the valve body assembly fluid channels. It is also a superior joint in terms of weld integrity.

In a third variation, the integrated valve body and syringe tube includes a valve body with a center filter cavity. The valve assembly is sealed by a cap that is joined by an ultrasonic butt weld or any suitable means. The valve assembly can include a gasket to provide additional sealing. The substrate can be formed of polypropylene, copolyester, polycarbonate, or any suitable material. The gasket can be formed of an elastomer or any suitable material.

In a fourth variation, the integrated valve body and syringe tube includes a valve body with a center filter cavity for the filter. The valve assembly is sealed by a cap that is joined by a laser weld lap joint or any suitable means. The valve assembly can include a gasket to provide additional sealing. The substrate can be formed of polypropylene, copolyester, or any suitable material. The gasket can be formed of an elastomer or any suitable material. The laser weld joint eliminates ultrasonic welding and the associated welded-in stresses and particulates released into the fluid domain during the welding process. Furthermore, it eliminates the dependency of filter compression on the welding process and allows filter compression to be precisely controlled only by relevant component stackup dimensions.

In a fifth variation, the integrated valve body and syringe tube includes a valve body with an off-center filter cavity for the filter, which allows additional clearance for fluid flow paths to improve fluid flow and reduce possible contamination between flow paths. The valve assembly is sealed by a cap that is joined by an ultrasonic shear weld or any suitable means. In some embodiments, this design can provide suitable sealing such that no gasket is needed. The substrate can be formed of polycarbonate, copolyester, or any suitable material. The shear weld joint in a two-part valve body assembly enables precise control of filter compression which allows better control of fluidics and relevant performance metrics such as filter capture, backpressure, and pressure aborts within the valve body assembly fluid channels. It is also a superior joint in terms of weld integrity.

In a sixth variation, the integrated valve body and syringe tube includes a valve body with an off-center filter cavity for the filter, allowing clearance for fluid flow paths to improve fluid flow and reduce possible contamination between flow paths. The valve assembly is sealed by a cap that is joined by an ultrasonic shear weld. The valve assembly can include a gasket to provide additional sealing. The substrate can be formed of polycarbonate, copolyester, or any suitable material. The gasket can be formed of an elastomer or any suitable material. The use of a gasket on an integrated valve body syringe tube allows the removal of the gasket from the cartridge body, which simplifies the molding process of the unitary cartridge body.

In a seventh variation, the integrated valve body and syringe tube includes a valve body with an off-center filter cavity for the filter, which allows clearance for fluid flow paths to improve fluid flow and reduce possible contamination between flow paths. The valve assembly is sealed by a thin film seal, which can be heat sealed, adhesively sealed, or sealed by any suitable means. The thin film can be a polymer, such as polyester, or any suitable material. In some embodiments, this design can provide suitable sealing such that no gasket is needed. The substrate can be formed of polycarbonate, copolyester, polypropylene or any suitable material. This variation eliminates another injection molded component, the valve cap, and replaces it with a film. The above noted features and variations are particularly advantageous when used with a unitary cartridge body. A unitary cartridge body can be understood by referring to U.S. patent application Ser. No. 18/184,326 filed March 15, entitled “Unitary Cartridge Body and Associated Components and Methods of Manufacture,” the entire contents of which are incorporated herein by reference for all purposes.

In an eighth variation, the integrated valve body and syringe tube includes a valve body with two off-center filter cavities. In some embodiments, these can be used for two filters, which can allow for additional capacity or allow for use of different types to perform differing types of processing or detection of differing targets. In some embodiments, the additional filter cavity can be used with a valve as discussed further below.

In a ninth variation, the integrated valve body can include one or more valves along any of the flow channels and/or ports defined therein or within an additional filter cavity. The one or more valves can include one-way valves, two-way valves or any combination thereof. In some embodiments, the one or more valves can lead to one or more ports to facilitate fluid flow into and/or out from the cartridge. In other embodiments, the one or more valves can be configured to selectively facilitate or inhibit flow through certain ports or through flow channels so as to improve fluid flow control and further inhibit cross-contamination and improve efficiency. The one or more valves can include deformable membranes, stoppers, mechanical valves or any suitable means of controlling fluid flow.

It is appreciated that geometries and dimensions of fluid channels, fluid domains, filter pockets, flow valves, ports, weld joints can vary based on further analysis, testing, and experimentation throughout the product life cycle including depth, width, length, diameter of ports, angles of channel/filter pocket openings and intersections on both the valve body and cap.

### BRIEF DESCRIPTION OF THE DRAWINGS

FIGS. 1A-1B show a sample cartridge having a valve assembly configured for performing differing sample processes, including chemical lysing of targets, which is configured for PCR and optional integrated nucleic acid analysis of the target assay panel in accordance with some embodiments. FIG. 1A shows the sample cartridge body with reaction vessel attached,

FIG. 1B shows an exploded view of the sample cartridge.

FIG. 2 shows a conventional sample cartridge having a sub-assembly with separable syringe tube and valve assembly components.

FIG. 3 shows a sample cartridge having an integrated syringe tube and valve assembly, in accordance with aspects of the invention.

FIGS. 4A-4C show illustrative, but non-limiting embodiments of the modules, and systems (e.g., processing units) for the PCR detection and/or quantification of polypeptide(s) and optional integrated nucleic acid analysis for the targeted assay panel. FIG. 4A illustrates a module configured to receive and interact with the valve assembly of the cartridge to operate the cartridge to facilitate sample preparation and analysis. FIG. 4B illustrates a processing unit (e.g. analytical testing unit) of the module that interacts with the fluid sample in the reaction vessel to facilitate sample processing and analytical testing (e.g. PCR and, optionally, nucleic acid analysis) for the targeted assay panel. FIG. 4C illustrates an analytical system having multiple such modules within an enclosure so as to receive multiple sample cartridges therein for testing of the targeted assay panel and/or various other targets or panels.

FIG. 5 shows a non-limiting workflow for PCR and optional nucleic acid analysis (e.g., nucleic acid amplification) of the targeted assay using a sample cartridge, in accordance with some embodiments.

FIGS. 6A-12D show variations of integrated valve body and syringe tube, in accordance with some embodiments.

FIGS. 13A and 13B show an exemplary valve body design having a filter cavity and flow paths along a common plane, in accordance with some embodiments, and FIGS. 13C-1 to 13C-3 show the associated volumes of the exemplary valve body design.

FIGS. 14A-14D show flow simulations through the various flow channels of the exemplary valve body design of FIGS. 13A-13C demonstrating a reduction in carryover and contamination as compared to conventional designs, in accordance with some embodiments.

FIG. 15 shows another exemplary valve body having two offset filter cavities, in accordance with some embodiments.

FIGS. 16A-16C show another integrated valve body and syringe tube that includes a valve body having a valve to an external port, in accordance with some embodiments.

FIGS. 17A-17B show cap designs having the external valve or external port for use with a valve body of FIG. 18 having two filter cavities, in accordance with some embodiments.

FIGS. 19A-19B show the exemplary valve assembly with the valve in the closed position, in accordance with some embodiments.

FIGS. 20A-20B show the exemplary valve assembly with the valve in the closed position, in accordance with some embodiments.

### DETAILED DESCRIPTION

The present invention relates generally to sample assay cartridges in the field of biochemical analysis for a targeted assay panel that includes rotatable valve body and syringe tubes that facilitate controlled fluid flow between various chambers of the cartridge. The invention pertains to one or more features of an integrated syringe tube and valve assembly.

### I. System Overview

In one aspect, the invention pertains to a sample cartridge that utilizes a valve body platform that allows for the detection of enveloped and free nucleic acid targets. In some embodiments, the valve body includes a sample processing region or lysing chamber that provides for either or both mechanical and chemical lysis. This allows a single cartridge to provide lysing for a multitude of differing types of targets, thus, can be considered an “assay panel cartridge.” In some embodiments, the sample cartridge can perform processing and detection of both bacterial targets requiring mechanical lysing and viral targets suited for chemical lysing.

The sample cartridge device can be any device configured to perform one or more process steps relating to preparation and/or analysis of a biological fluid sample according to any of the methods described herein. In some embodiments, the sample cartridge device is configured to perform at least sample preparation. The sample cartridge can further be configured to perform additional processes, such as detection of a target nucleic acid in a nucleic acid amplification test (NAAT), e.g., Polymerase Chain Reaction (PCR) assay, by use of a reaction vessel attached to the sample cartridge. In some embodiments, the reaction vessel extends from the body of the cartridge. Preparation of a fluid sample generally involves a series of processing steps, which can include chemical, electrical, mechanical, thermal, optical or acoustical processing steps according to a specific protocol. Such steps can be used to perform various sample preparation functions, such as cell capture, cell lysis, binding of analyte, and binding of unwanted material.

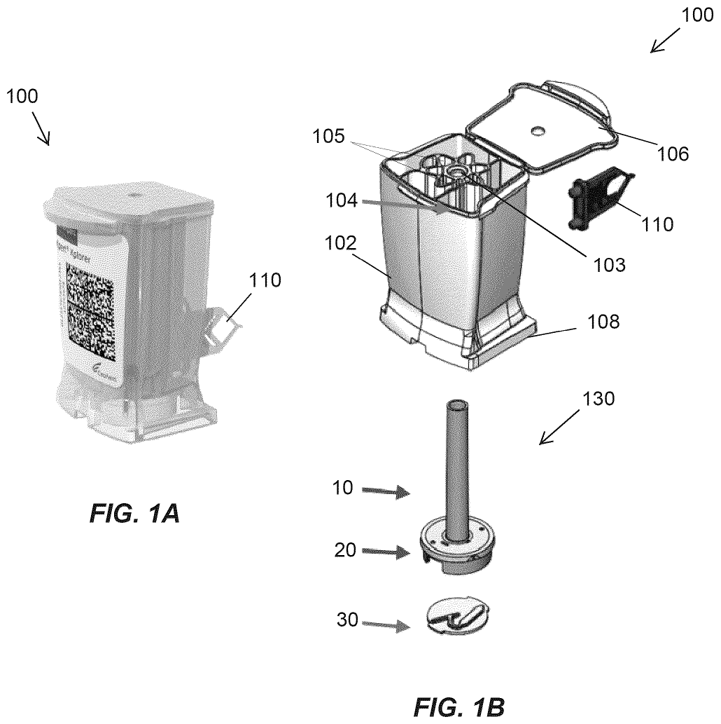

A sample cartridge suitable for use with the invention, includes one or more transfer ports through which the prepared fluid sample can be transported into an attached reaction vessel for analysis. FIG. 1A illustrates an exemplary assay panel cartridge 100 suitable for sample preparation and analytics testing by PCR when received in an instrument module in accordance with some embodiments. The sample cartridge is attached with a reaction vessel 110 (also referred to as a “reaction tube” or “PCR tube”) adapted for analysis of a fluid sample processed within the sample cartridge 100. In some embodiments the reaction vessel extends from the cartridge body.

As can be seen in the exploded view of FIG. 1B, the sample cartridge 100 includes various components including a main housing 102 having a sample chamber 104, multiple processing chambers 105 for processing of the fluid sample distributed about a central syringe tube conduit 103 to facilitate sample preparation before analysis, a lid 106 and base 108. It is noted that the lid and base can be integrally formed with the cartridge body or can be separate components, for example, as in the unitary cartridge body referenced above. The cartridge includes an integrated valve body and syringe tube component 130. The instrument module facilitates the processing steps to move the fluid sample between processing chambers in order to perform sample preparation transport the prepared fluid sample into fluid conduits of the reaction vessel 110 attached to the housing of the sample cartridge 100. The prepared biological fluid sample is further advanced into a reaction chamber of the reaction vessel where the biological fluid sample undergoes nucleic acid amplification. In some embodiments, the amplification is a polymerase chain reaction. In some embodiments, concurrent with the amplification of the biological fluid sample, an excitation means, and an optical detection means of the module is used to detect optical emissions that indicate the presence or absence of a target nucleic acid analyte of interest, e.g., bacteria, virus, pathogen, toxin, or other target analyte. The optical detection means can include 4 or more optical channels, preferably six or more optical channels, more preferably ten or more optical channels. It is appreciated that such a reaction vessel could include various differing chambers, conduits, or micro-well arrays for use in detecting the target analyte. The sample cartridge can be provided with means to perform preparation of the biological fluid sample before transport into the reaction vessel. Any chemical reagent required for viral or cell lysis, or means for binding or detecting an analyte of interest (e.g. reagent beads) can be contained within one or more chambers of the sample cartridge, and as such can be used for sample preparation.

An exemplary use of a reaction vessel for analyzing a biological fluid sample is described in commonly assigned U.S. Pat. No. 6,818,185, entitled “Cartridge for Conducting a Chemical Reaction,” filed May 30, 2000, the entire contents of which are incorporated herein by reference for all purposes. Examples of the sample cartridge and associated modules are shown and described in U.S. Pat. No. 6,374,684, entitled “Fluid Control and Processing System” filed Aug. 25, 2000, and U.S. Pat. No. 8,048,386, entitled “Fluid Processing and Control,” filed Feb. 25, 2002, U.S. Patent Application No. 63/217,672 entitled “Universal Assay Cartridge and Methods of Use” filed Jul. 1, 2021; U.S. Provisional Application No. 63/319,993 entitled “Unitary Cartridge Body and Associated Components and Methods of Manufacture” filed Mar. 15, 2022; and U.S. Pat. No. 10,562,030 entitled “Molecular Diagnostic Assay System” filed Jul. 22, 2016; the entire contents of which are incorporated herein by reference in their entirety for all purposes.

Various aspects of the sample cartridge 100 can be further understood by referring to U.S. Pat. No. 6,374,684 (“the '684 patent”), which described certain aspects of a sample cartridge in greater detail. Such sample cartridges can include a fluid control mechanism, such as a rotary fluid control valve assembly, that is fluidically connected to the chambers of the sample cartridge. The term “chamber” can be used interchangeably with the terms “well”, “tube”, and the like. Rotation of the rotary fluid control valve body permits fluidic communication between chambers and the valve so as to control flow of a biological fluid sample deposited in the cartridge into different chambers in which various reagents can be provided according to a particular protocol as needed to prepare the biological fluid sample for analysis. To operate the rotary valve, the cartridge processing module comprises a motor such as a stepper motor that is typically coupled to a drive train that engages with a feature of the valve in the sample cartridge to control movement of the valve in coordination with movement of the syringe, thereby resulting movement of the fluid sample according to the desired sample preparation protocol. The fluid metering and distribution function of the rotary valve according to a particular sample preparation protocol is demonstrated in the '684 patent.

### II. Example Assay Cartridge and Valve Assemblies

### A. Overview

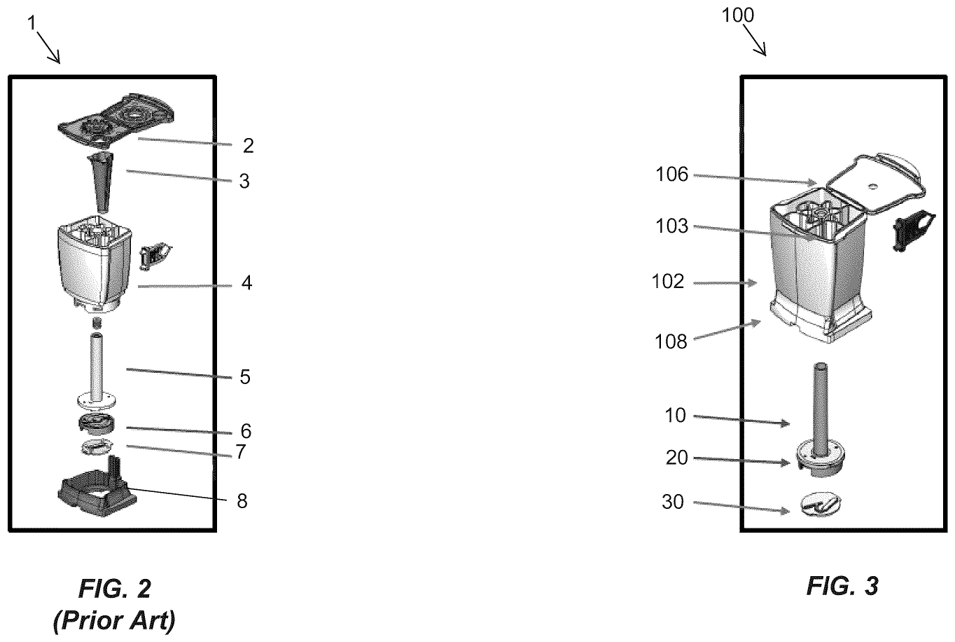

As shown in FIGS. 1A-1B and 3, the assay panel cartridge 100 comprises a cartridge body 102 containing a plurality of chambers 105 for reagents or buffers and sample processing and the integrated valve body and syringe tube 130, which includes a syringe tube 10 extends to a valve body 20 that is sealed on an underside by a cap 30. The chambers 105 are disposed around a central syringe barrel conduit 103 that is in fluid communication with the valve body 20 of the integrated syringe tube valve assembly 130 through the syringe tube 10. The valve body typically contains one or more channels or cavities (chamber(s) 114) that can contain a filter as described herein that can function to bind and elute a nucleic acid. In some embodiments the cartridge further comprises one or more temperature controlled channels or chambers that can, in certain embodiments, function as thermocycling chambers. A “plunger” not shown can be operated to draw fluid into the syringe barrel 103 and rotation of the valve body 20 aligns the ports on a top side thereof with corresponding ports in the respective chambers to provide selective fluid communication between the various reagent chambers and channels, reaction chamber(s), mixing chambers, and optionally, any temperature controlled regions. Thus, the various reagent chambers 105, reaction chambers, filter material(s), and temperature controlled chambers or channels are selectively in fluid communication by rotation of the valve body and syringe tube and reagent movement (e.g., chamber loading or unloading) is operated by the “syringe” action of the plunger within the syringe tube. By comparison, FIG. 2 shows the various separate components of a conventional cartridge 1 having a lid apparatus 2, a plunger barrel 3, cartridge body 4, syringe tube 5, valve body 6, sealing cap 7 and cartridge foot 8. While a unitary cartridge body is shown here, it is appreciated that the integrated valve body and syringe tube can be used with various other cartridges includes legacy cartridges having separately attached lid assemblies.

### B. Example Valve Assemblies

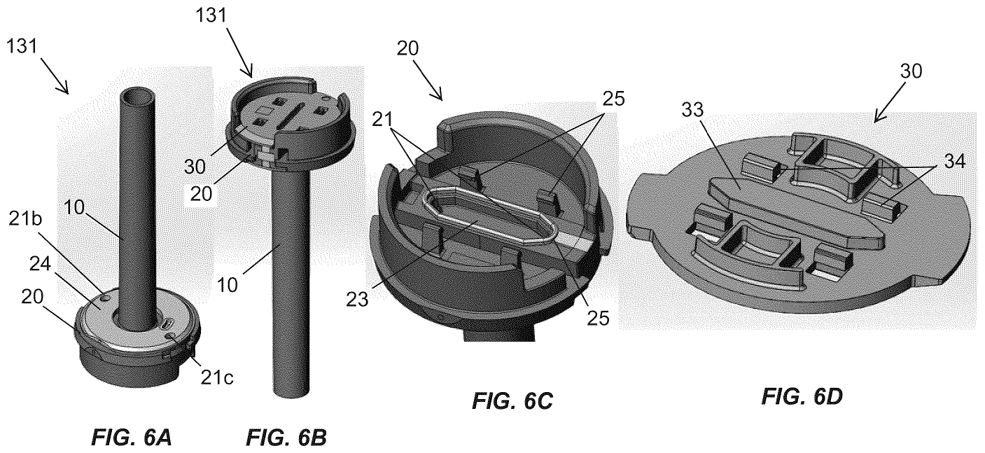

The valve assemblies presented herein are configured to perform chemical lysing which is typically suited for lysing less hardy targets (e.g. viruses, free NA, some spores, some bacteria and yeasts). In such cartridges, the valve assembly includes the syringe tube 10, valve body 20, and valve cap 30. In some embodiments, the valve body can be sealed by a thin film instead of a cap. As discussed above, the syringe tube and valve body can be formed as an integral component, which simplifies ease in manufacturing and assembly. As can be understood further by the embodiments in FIGS. 6A-12D, the valve assemblies for chemical lysing typically include a valve body with an oblong filter recess that receives a glass filter (e.g. glass column), the glass filter is configured for binding with nucleic acid released from the target by chemical lysing. It is appreciated that various other shapes and types of filters could be used, but typically the filter utilizes glass or glass fibers to form the filter facilitates affinity bonding with the free nucleic acid released by chemical lysing.

### C. Reaction Modules

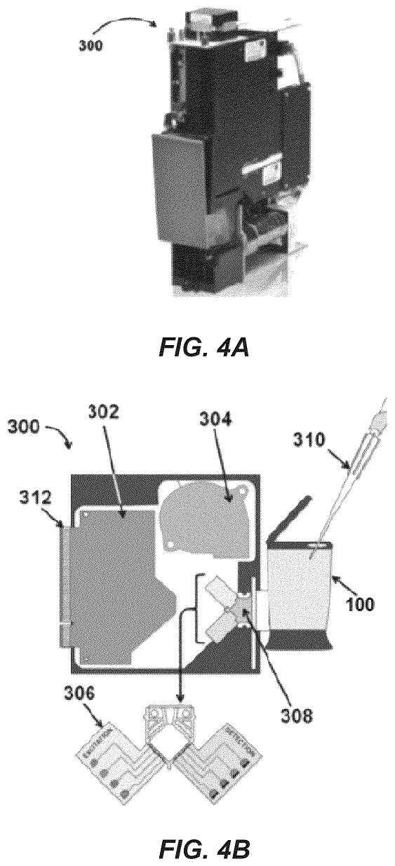

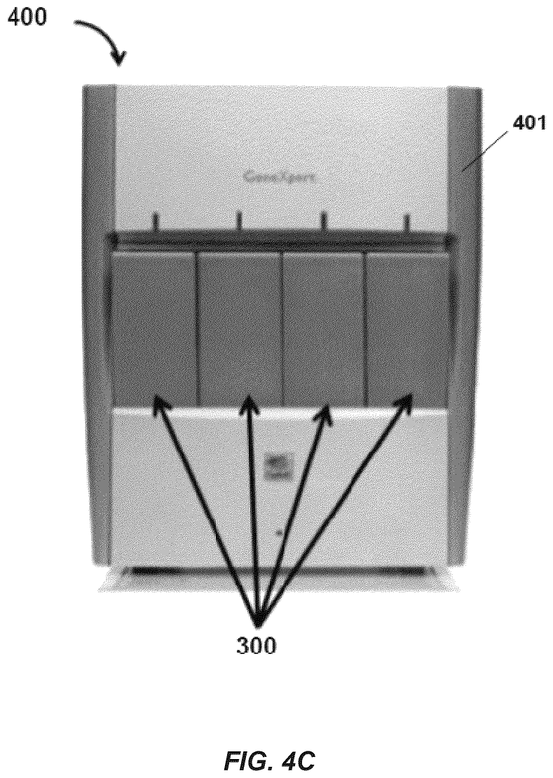

In certain embodiments the cartridge 100 is configured for insertion into a reaction module 300, e.g., as shown in FIG. 4A. As illustrated in FIG. 4B the module is configured to receive the cartridge 100 therein. In certain embodiments the reaction module provides heating plates 308 to heat the temperature controlled chamber or channel. The module can optionally additionally include a fan 304 to provide cooling where the temperature controlled channel or chamber is a thermocycling channel or chamber. Electronic circuitry 302 can be provided to pass information (e.g., optical information) top a computer for analysis. In certain embodiments the module can contain optical blocks 306 to provide excitation and/or detection of one or more (e.g., 1, 2, 3, 4, or more) optical signals representing, e.g., signal DNAs amplified for various PCR targets. In various embodiments an electrical connector 312 can be provided for interfacing the module with a system (e.g. system controller or with a discrete analysis/controller unit. As illustrated, in FIG. 4B the sample can be introduced into the cartridge using a pipette 310. In certain embodiments, the module also contains a controller that operates a plunger in the syringe barrel and the rotation of the valve body.

### D. Analytical System

In certain embodiments a system (e.g., a processing unit) is provided. One illustrative, but non-limiting embodiment is shown in FIG. 4C. System 400 includes an enclosure 401 that is configured to support and power multiple sample processing modules 300, where each processing module is configured to hold and operate a removable cartridge 100. In some embodiments, the system is configured to operate the sample processing modules to perform a PCR assay for one or more target analytes and optionally to determine the level of one or more target RNA/DNA sequences within a corresponding removable sample cartridge. Typically, the processing on a sample within the corresponding removable sample cartridge involves operating the cartridge to perform a method as described herein. In certain embodiments the system is configured to contain one sample processing module. In certain embodiments the system is configured to contain at least two or more sample processing modules (e.g., at least 4, 8, 12, 16, 20, 24, 28, 32, 48, 80, or more) sample processing modules. In some embodiments, the system provides a user interface that allows the user input operational instructions and/or to monitor operation of the cartridges to determine the presence or quantity of one or more nucleic acids.

While the methods described herein are described primarily with reference to the GENEXPERT® cartridge by Cepheid Inc. (Sunnyvale, Calif.) (see, e.g., FIG. 1A), it will be recognized, that in view of the teachings provided herein the methods can be implemented on other cartridge/microfluidic systems, including alternative cartridge designs having valve assemblies that involve multiple interfacing components, as well as cartridge body defined by multiple interfacing components to form the multiple chambers of the cartridges, for example, those described in Korean Application No. 102293717B1 and KR102362853B1, cartridges that utilizes ultrasonic waves to lyse cells in a biological sample, for example, those described in International Application No. WO2021/245390A1, cartridges and systems that utilizes an electrowetting grid for microdroplet manipulation and electrosensor arrays configured to detect analytes of interest, for example, those described in International Application No. WO2016/077341A2, cartridges that facilitate movement of nucleic acid from one chamber to the next chamber by opening a vent pocket, for example, those described in International Application No. WO2012/145730A2, multiplexed assay systems comprising a plurality of thermocycling units such that individual chambers can be heated, cooled, and/or compressed to mix fluid within the chamber or to propel fluid in the chamber into another chamber, for example, those described in International Application No. WO2015/138343A1, and as well as systems for rapid amplification of nucleic acids facilitated by flexible portions of the sample cartridge aligned to accomplish temperature cycling for nucleic acid amplification, for example, those described in International Application No. WO2017/147085A1. Such cartridge systems can include, for example microfluidic systems implemented using soft lithography, micro/nano-fabricated microfluidic systems implemented using hard lithography, and the like.

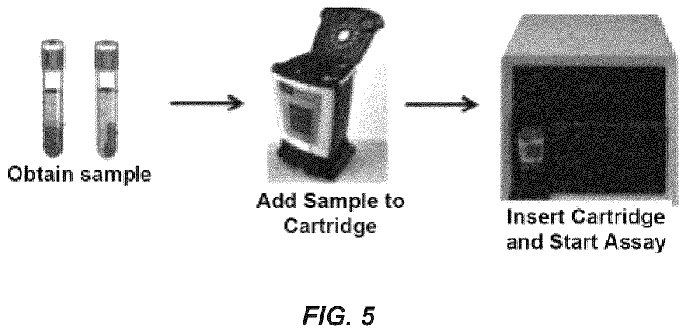

FIG. 5 shows a non-limiting workflow for PCR and optional nucleic acid analysis (e.g., nucleic acid amplification) of the targeted assay with a sample cartridge. In some embodiments, PCR and nucleic acid analysis when performed, are both performed on the same sample. Thus, a single sample can be introduced into one sample chamber. In other embodiments the sample may be processed differently for PCR and nucleic acid analysis for the target assay panel.

### III. Example Integrated Syringe Tube Valve Components

As described herein, the invention pertains to integrated valve body and syringe tube which can be formed as in integral component, whereas conventional designs utilize separate syringe tubes and valve bodys that are coupled together via three-part simultaneous ultrasonic welding. This concept results in fewer parts which results in reduced tolerance stackup and a two-part welding stack, which improves welding control, repeatability, and overall manufacturing process reliability. This integrated design also allows use of improved joint types and technologies that improve ease of manufacturability in addition to improved reliability for the end-user. Due to fewer non-conformances (NCs), there are less failures as a result of manufacturing processes. In some embodiments, the valve body has been re-designed to inhibit cross-contamination while balancing other design for manufacturing (DFM) and functional requirements of the product. Further details are shown and discussed in the embodiments below.

FIGS. 6A-6D show a first variation of an integrated valve body and syringe tube 131, in accordance with some embodiments. In this first variation, the integrated valve body and syringe tube includes a valve body with a center filter cavity 23 in an underside for the filter (not shown). The central cavity is an elongated cavity configured to fittingly receive the filter (e.g. glass tube). The valve body includes an inlet and outlet filter ports 21 at opposite ends of the filter cavity, which extend to outlet ports 21b, 21c on the top side of the valve body, so that sample fluid injected from one chamber the syringe tube is filtered by the filter before exiting through an outlet port into another chamber. This arrangement of inlet and outlet ports are applicable to all of the embodiments discussed herein. In this embodiment, a direct path from a syringe port to a direct port is located elsewhere in the valve body, for example, an upper region, which can be formed in the valve body or formed in an overmolded material. As shown in FIG. 6C, the filter cavity 23 and flow path is formed in an underside of the valve body, which is sealed by a cap 30. The cap can be joined to the valve body by a snap-fit interface or any suitable means. In this embodiment, the valve body can include coupling features 25, such as resilient tabs or hooks that engage with corresponding coupling features 34 of the cap. The cap can further include a cavity shaped protrusion 33 that protrudes into the cavity 23. In one aspect, the cap design is dependent on joint design and is a modification of existing production components minus the joint designs (e.g. snap fit, shear weld, etc.). The valve assembly can further include a gasket 24 to provide additional sealing. The gasket can be formed of an elastomer or any suitable material. In some embodiments, the gasket is an overmold that is injection molded into the valve body. The substrate can be formed of polypropylene or any suitable material. One advantage of this variation is that welding connections can be eliminated.

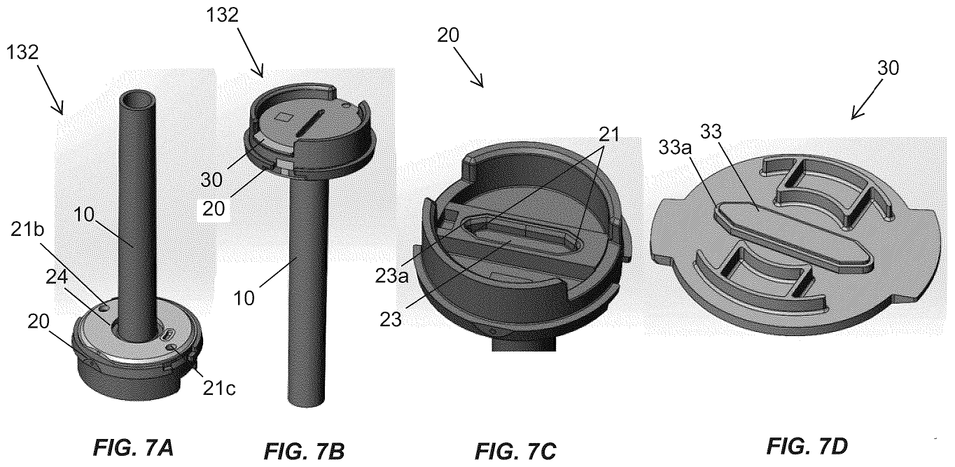

FIGS. 7A-7D show a second variation of an integrated valve body syringe tube 132, in accordance with some embodiments. In this second variation, the integrated valve body syringe tube includes a syringe tube 10 that extends to a valve body 20 with a center filter cavity 23 in an underside for the filter (not shown). The valve body includes an inlet and outlet filter ports 21 at opposite ends of the filter cavity so that sample fluid injected from the inlet is filtered by the filter before exiting through the outlet. In this embodiment, the filter cavity is disposed in a center position. In this embodiment, a direct path from a syringe port to the direct port is located elsewhere in the valve body, for example, an upper region, which can be formed in the overmold material. The underside cavity of the valve body is sealed by a cap 30. The cap can be joined by an ultrasonic shear weld or any suitable means. To facilitate sealing, the valve body can include a ridge 23a about the periphery of the filter cavity that interfaces with a corresponding recess or chamfer 33a in the cavity shaped protrusion 33 of the cap. The valve assembly can include a gasket 24 to provide additional sealing. The gasket can be formed of an elastomer or any suitable material. In some embodiments, the gasket is an overmold that is injection molded into the valve body. The substrate can be formed of polypropylene, copolyester, polycarbonate, or any suitable material.

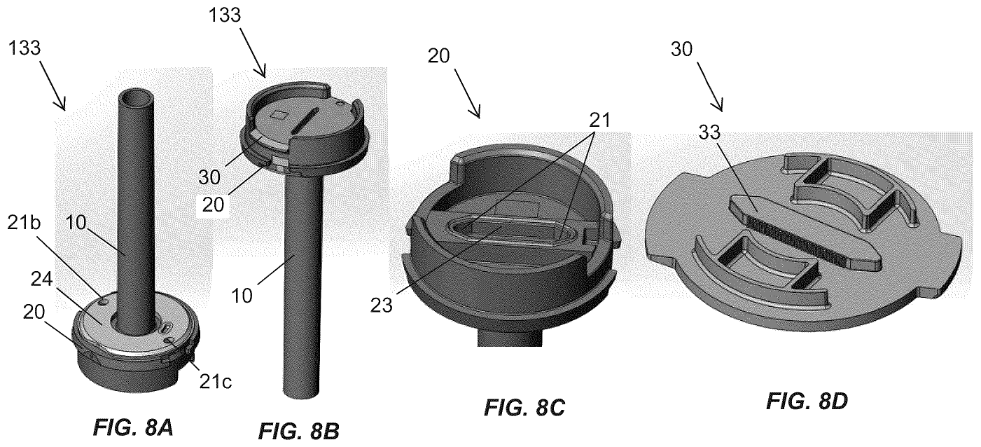

FIGS. 8A-8D show a third variation of an integrated valve body syringe tube 133, in accordance with some embodiments. In this third variation, the integrated valve body syringe tube 133 includes a syringe tube 10 that extends to a valve body 20 with a center filter cavity 23 in an underside for the filter (not shown). The valve body includes an inlet and outlet filter ports 21 at opposite ends of the filter cavity so that sample fluid injected from the inlet is filtered by the filter before exiting through an outlet port 21c. In this embodiment, a direct path from a syringe port to a direct port is located elsewhere in the valve body, for example, an upper region, which can be formed in the overmolded material. The underside cavity of the valve body is sealed by a cap 30. The cap can be joined by an ultrasonic butt weld or any suitable means. The cavity can include a ridge about the periphery and/or ridges can be provided on the cavity-shaped protrusion 33 to facilitate sealing. The valve assembly can further include a gasket 24 to provide additional sealing. The gasket can be formed of an elastomer or any suitable material. In some embodiments, the gasket is an overmold that is injection molded into the valve body. The substrate can be formed of polypropylene, copolyester, polycarbonate, or any suitable material.

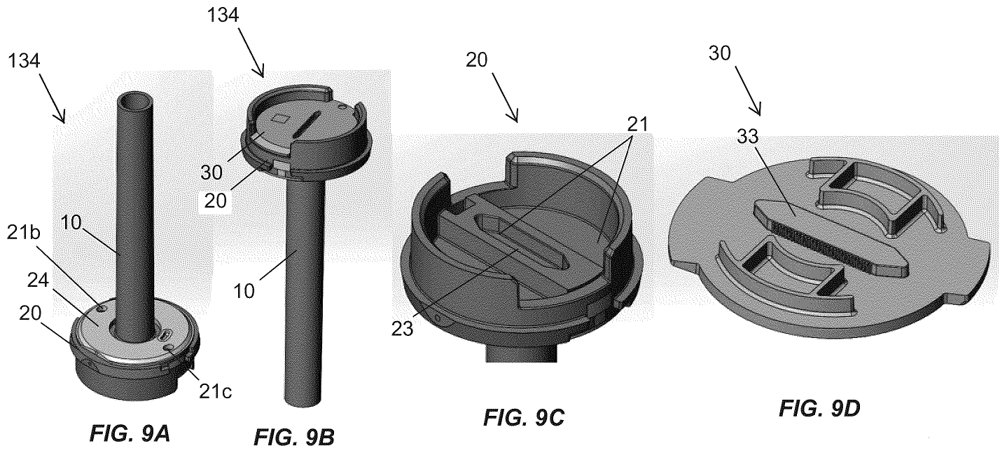

FIGS. 9A-9D show a fourth variation of an integrated valve body syringe tube 134, in accordance with some embodiments. In this fourth variation, the integrated valve body syringe tube 134 includes a syringe tube 10 that extends to a valve body 20 with a center filter cavity 23 in an underside for the filter (not shown). The valve body includes an inlet and outlet filter ports 21 at opposite ends of the filter cavity so that sample fluid injected from the inlet is filtered by the filter before exiting through the outlet port 21c. In this embodiment, a direct path from a syringe port to a direct port is located elsewhere in the valve body, for example, an upper region, which can be formed in the overmold material. The underside cavity of the valve body is sealed by a cap 30. The cap can be joined by a laser weld lap joint or any suitable means. The cavity can include a ridge about the periphery and/or ridges (e.g. vertical ridges) can be provided on the cavity-shaped protrusion 33 to facilitate sealing. The valve assembly can further include a gasket 24 to provide additional sealing. The gasket can be formed of an elastomer or any suitable material. The gasket can be an overmold that is injection molded into the valve body. The substrate can be formed of polypropylene, copolyester, polycarbonate, or any suitable material.

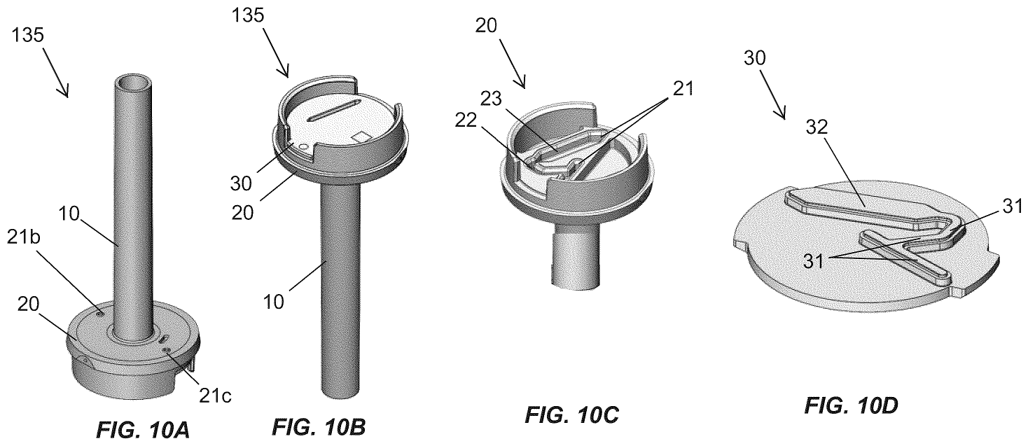

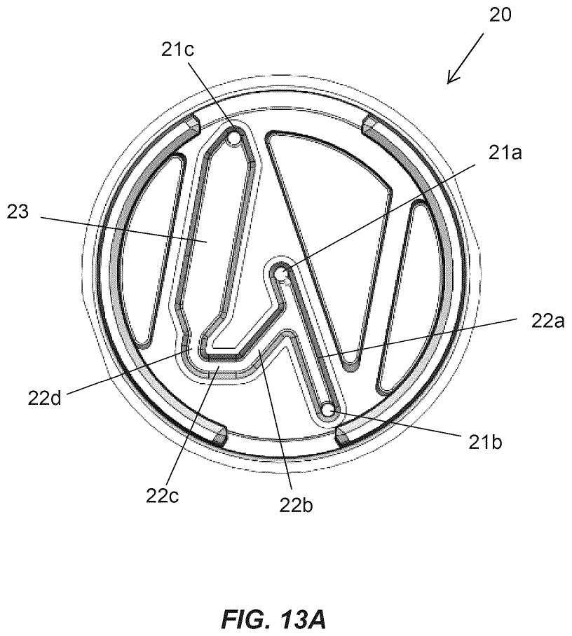

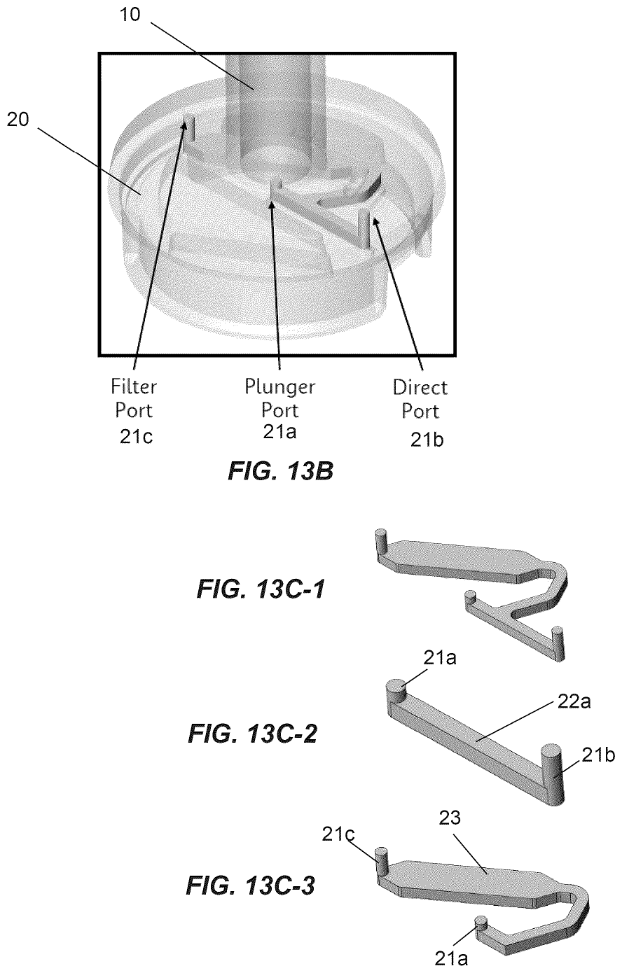

FIGS. 10A-10D show a fifth variation of an integrated valve body syringe tube 135, in accordance with some embodiments. In this fifth variation, the integrated valve body syringe tube 135 includes a syringe tube 10 that extends to a valve body 20 with off-center filter cavity in the underside of the valve body, flow paths 22 and ports 21. This placement of the filter cavity allows additional clearance to include additional fluid paths (e.g. direct fluid flow path) that are provided elsewhere in prior embodiments. Advantageously, this allows the fluid flow paths in the valve body to be provided along a common plane, which can improve fluid flow and ease of manufacture. Additionally, the fluid flow paths can be designed and angled to improve fluid flow and reduce possible carryover or contamination between and within flow paths. The valve body and flow paths can be further understood by referring to FIG. 13 below. The underside cavity of the valve body is sealed by a cap 30 that is shaped to be fitting received in the underside of the valve body and having protrusions 31, 32 shaped to be partly received within the cavity and flow paths to facilitate sealing. The cap can be joined by a weld, such as an ultrasonic shear weld, or any suitable means. The cavity and flow paths and and/or protrusions can include interfacing ridge and recess about the periphery to facilitate sealing. In some embodiment, this design can provide suitable sealing such that no gasket is needed for sealing or to provide the direct flow path. The substrate can be formed of polycarbonate, copolyester, or any suitable material.

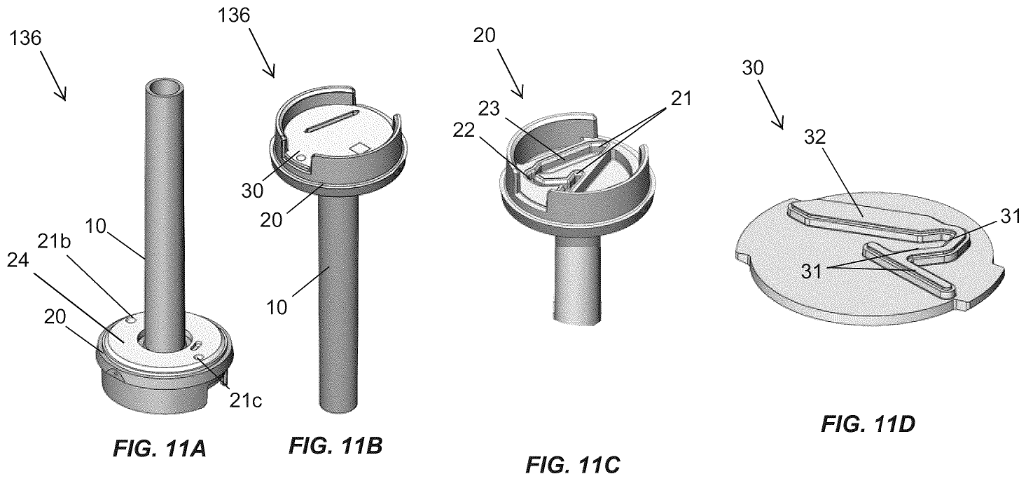

FIGS. 11A-11D show a sixth variation of an integrated valve body syringe tube 136, in accordance with some embodiments. In this sixth variation, the integrated valve body syringe tube 136 includes same or similar features as those noted above in FIGS. 10A-10D. However, in this embodiment the component can further include a gasket 24. The gasket can be an elastomer or any suitable material to provide additional sealing and/or flow paths. Additionally, the use of a gasket on the valve-body syringe tube component allows the removal of the gasket from the unitary cartridge body, thereby simplifying the molding process of the unitary cartridge body.

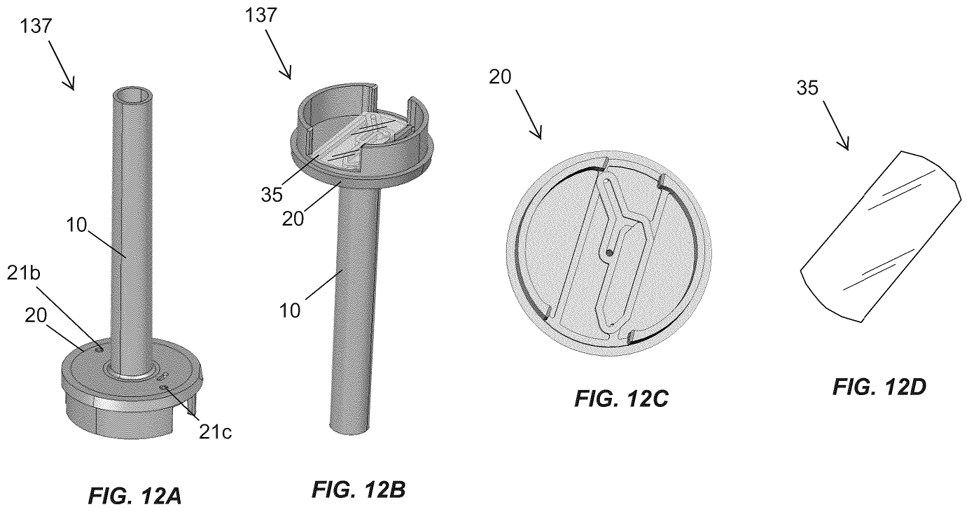

FIGS. 12A-12D shows a seventh variation of an integrated valve body syringe tube 137, in accordance with some embodiments. In this seventh variation, the integrated valve body syringe tube 137 includes same or similar features as those noted above in FIGS. 10A-10D. However, in this embodiment, instead of a cap, the valve body is sealed by a thin film 35. Thin film 35 can be sealed by heat sealing, adhesive or chemical bonding, or any suitable means. The film can be polyester or any suitable film material. In the embodiment shown, as in some previous embodiments, the filter cavity 23 is off-center to allow additional flowpaths (e.g. direct flow path) on the same plane as the filter flow path through the cavity and the associated ports (e.g. plunger port, direct port, filter port). Additionally, the design of the flowpaths has been further modified, as compared to the design in FIG. 13, to confine the flowpaths within a smaller area to facilitate sealing of the thin film by a sealing component that fits between the notches on each side of the peripheral ridge extending below the underside edge of the valve body.

FIGS. 13A-13C show additional details of the redesigned valve body having flowpaths along a common plane as the filter cavity, such as that in FIG. 10A. FIG. 13A shows an underside of the valve body having an off-center filter cavity 23 and a direct flowpath 22a. In this embodiment, the center port is a plunger port 21a, which receives fluid sample when the plunger is advanced through the syringe tube. The plunger port can be used with the direct path 22a to provide direct flow through direct port 21b into any of the chambers surrounding the central conduit by rotating the valve body to the appropriate position to place the direct port 21b open to atmosphere and in fluid communication with the respective chamber and the filter port 21c is sealed. The direct flow path can be used to facilitate processing of the fluid sample by mixing the fluid sample with one or more reagents or buffers disposed in any of the multiple chambers. Alternatively, the valve body can be rotated to a position in which the filter port 21c is open to atmosphere adjacent an open port of another chamber and the direct port 21 is sealed so that fluid flow from the plunger port 21a flow through an alternate fluid path (22b, 22c, 22d) and across the filter cavity 23 to be filtered by the glass filter before exiting into another chamber or channel via filter port 21c. In this embodiment, the alternative fluid path includes different segments that are angled and/or curved so as to inhibit inadvertent contamination from fluid flowing through the direct path. In this embodiment, a first flow path 22b extends from the direct path 22a at an acute angle (e.g. 30-60 degrees, about 45 degrees) to facilitate fluid flow. A second flowpath 22c is angled further toward the filter cavity 23 (e.g. between 10-30 degrees further). A third flow path 22d curves along a right angle or greater (e.g. between 90-120 degrees) to direct the fluid flow into the filter cavity.

FIG. 13B shows the flow channels of the exemplary valve body design, which shows the filter cavity and flow paths are disposed along a common plane. The flow paths include the direct flow path between the central plunger port 21a and direct port 21b and the filter flow path between the plunger port 21a and the filter port 21c. Each of the ports extends from the flow path layer and into the conduit of the syringe tube or to a top surface of the valve body to align with the respective chamber or channels to perform sample processing. FIG. 13B shows exemplary volumes for the total valve assembly, and for each of the direct path and the filter path through the filter cavity. It is appreciated that in other designs these volumes could vary (e.g. +/−10%, +/−20%, +/−30%) as needed for a particular application or assay cartridge design. FIG. 13C depicts the entire flowpath (top right), the direct flowpath (middle), and the filter path (lower right), and lists the volume for each in the production cartridge design as well as the integrated valve body syringe tube design. In some embodiments, this configuration approaches similar volumes as conventional cap designs so the control scheme for operating the cartridge can be substantially the same or similar. In this example, associated volumes of the channels for the integrated syringe tube valve body cap assembly are: 38.5 ul for the total volume (see FIG. 13C-1), 7.7 ul for the direct path volume (see FIG. 13C-2), and 33.1 ul for the filter path volume (see FIG. 13C-3). By comparison, the conventional design has similar associated volumes as follows: total volume of 35.8 ul, direct path volume of 7.9 ul, and filter path volume of 32.2 ul. It is appreciated however that it is not required that volumes remain the same or similar and that volumes can vary compared to current configurations.

It is appreciated that the above-described embodiments could include variations in angles and/or dimensions and still retain advantages of this novel design. Further, while this design is described within the context of an integrated valve body and syringe tube, it is appreciated this design could be utilized in various other components, or could be used in various other assay cartridges, such as a unibody cartridge or a conventional cartridge body design.

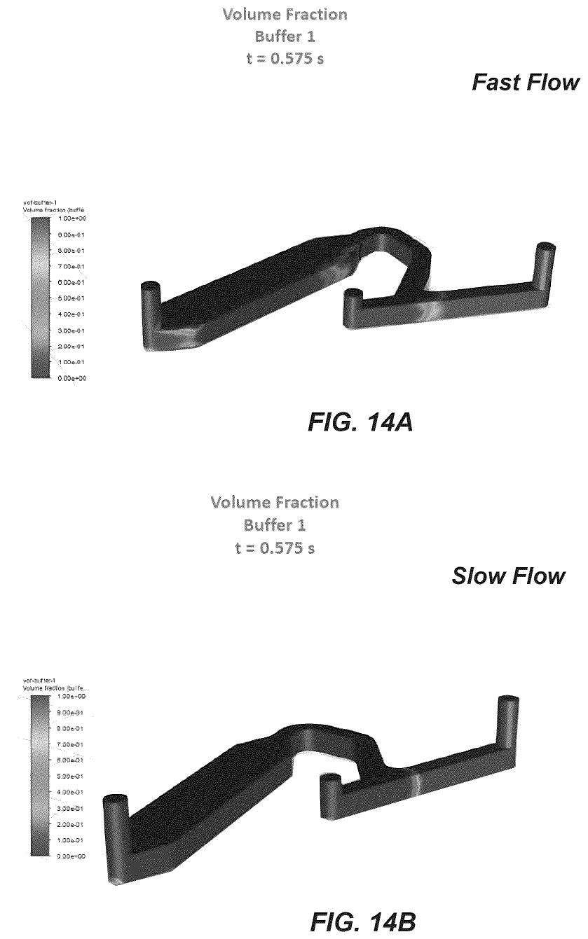

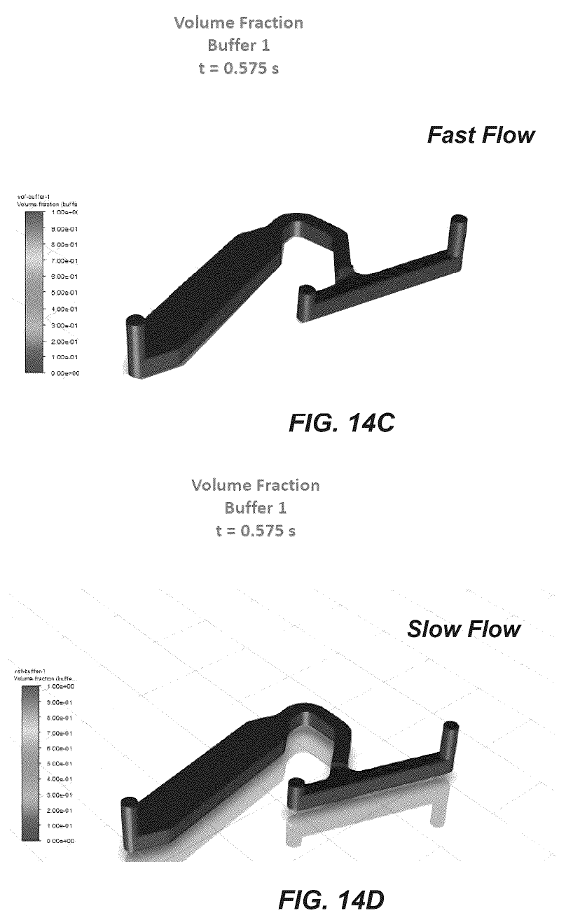

FIGS. 14A-14C show flow simulations through the various flow channels of the exemplary valve body design demonstrating the reduction in carryover/contamination in the design shown in FIGS. 13A-13C, in accordance with some embodiments. FIG. 14A shows a fast flow simulation of filter flow, where the plunger inlet direct port is blocked allowing fluid flow from the plunger port to the filter port for filtering of the fluid sample. FIG. 14B shows a slow flow simulation of filter flow, where the plunger inlet direct port is blocked allowing fluid flow from the plunger port to the filter port for filtering of the fluid sample. FIG. 14C shows a fast flow of direct flow between chambers where the plunger inlet filter port is blocked allowing fluid flow from the plunger port to the direct port open to atmosphere. FIG. 14D shows a slow flow simulation of direct flow, where the plunger inlet filter port is blocked allowing fluid flow from the plunger port to the direct port open to atmosphere. The simulations demonstrate a reduction in carryover (e.g. about 0.8% or greater), as compared to conventional valve body designs.

In another aspect, the integrated valve body and syringe tube can include various additional components or modifications to components that allow for additional functionality. Such components or modifications can include any of: i) variations of the integrated valve body that include one or more additional fluid domains (e.g. filter pocket or other cavity), which can optionally include a third gasket port and optionally a flow valve; ii) variations of the cap having additional protrusion features that match the additional fluid domain(s) as well as housing for additional flow valve(s) and corresponding flow channel(s); and iii) additional valve mechanisms, such as a one-way or two-way valves, for example, an insertable stopper that fits within a flow valve housing that defines a one-way valve. Examples of such components are shown in FIGS. 15-20B and described below.

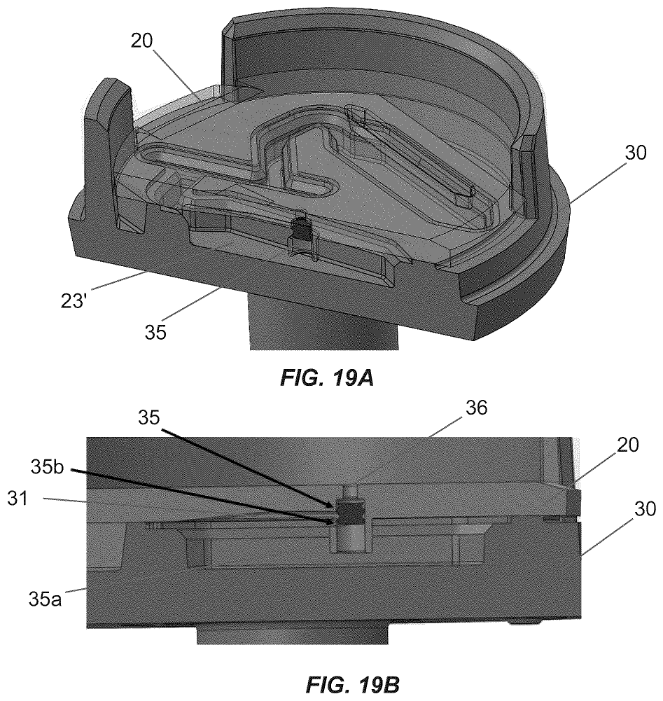

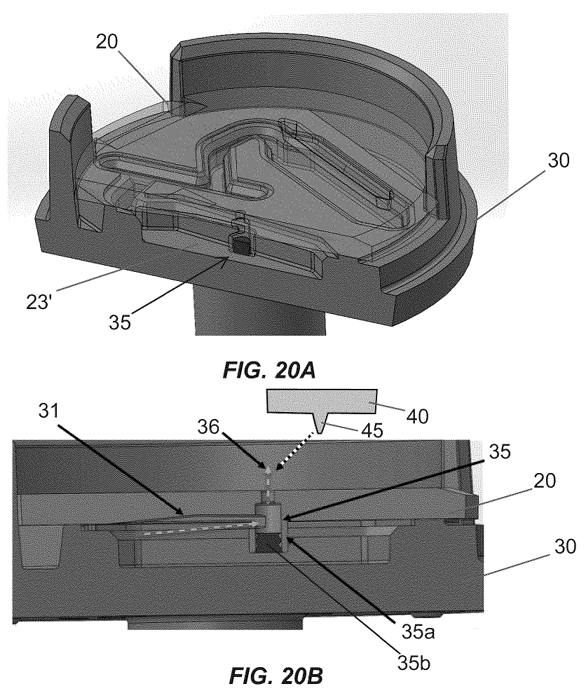

FIG. 15 show another exemplary valve body 20′ having an additional fluid domain, namely an additional filter cavity 23′. As shown, the valve body 20 has flowpaths along a common plane as the filter cavity, such as that in FIG. 10A, but has two such filter cavities. Similar to the previous embodiment in FIG. 13A, FIG. 15 shows an underside of the valve body having a direct flowpath 22a and offset filter cavity 23a, but further includes another offset filter cavity 23a that is connected by flowpath 22d′ to direct flowpath 22a. In this embodiment, the flowpatch 22d′ is elbow shaped having about a 90 degree turn, although it is appreciated that other configurations could be used. In this embodiment, the center port is a plunger port 21a, which receives fluid sample when the plunger is advanced through the syringe tube. The plunger port can be used with the direct path 22a to provide direct flow through direct port 21b into any of the chambers surrounding the central conduit by rotating the valve body to the appropriate position to place the direct port 21b open to atmosphere and in fluid communication with the respective chamber and the filter port 21c is sealed. The direct flow path can be used to facilitate processing of the fluid sample by mixing the fluid sample with one or more reagents or buffers disposed in any of the multiple chambers. Alternatively, the valve body can be rotated to a position in which the filter port 21c is open to atmosphere adjacent an open port of another chamber and the direct port 21 is sealed so that fluid flow from the plunger port 21a flow through an alternate fluid path (22b, 22c, 22d and 22d′) and across both filter cavities 23, 23′ to be filtered by the glass filter before exiting into another chamber or channel via filter port 21c. In some embodiments, the filter cavities can include differing types of filters, each configured for a particular target, thereby allowing for isolation of differing types of targets. In some embodiments, the valve body and/or cap can include a valve which allows one or both filter cavities to be selectively used as needed. In some embodiments, the filter cavity need not include a filter, but could act as a channel to an external port accessed via the valve, for example, as shown in FIGS. 19A-20B.

In another aspect, the integrated valve body syringe tube assembly can include an additional flow path and fluid domain (e.g. filter pocket) and an additional flow valve on the underside of the cap enabling flow of fluid into or outside of the cartridge via this additional flow valve. In some embodiments, the flow valve design can be one-way or two-way and can be defined by any standard or custom mechanism. In some embodiments, the valve is a film-sealed port that can be punctured by a corresponding male feature on an interfacing component/device or by an ad-hoc device. In another embodiment, the valve is a one-valve way mechanism having a rubber stopper which relies on a male feature (e.g. male Luer connector) on an interfacing component that moves the stopper thereby exposing the port and creating a flow channel from inside the valve body assembly to outside the cartridge into the interfacing component or external device. The interface component can be part of the module, previously shown and described. Fluid flow can occur via gravity, positive pressure driven by the plunger in the cartridge, and/or by negative pressure driven by the interfacing component or external device.

It is appreciated that fluid channels can be modified to add additional flow paths, additional domains (e.g. filter pockets, chambers), and/or additional one-way or two-way valves of varying geometries and dimensions, such as in the examples discussed further below. Relevant features on the cap can include corresponding modifications. It is appreciated that geometries and dimensions of valves, valve housings, fluid channels, fluid domains, filter pockets, weld joints can vary based on further analysis, testing, and experimentation throughout the product life cycle including depth, width, length, diameter of ports, angles of channel/filter pocket openings and intersections on both the valve body and the cap. The cap and valve housing materials can be of same or similar materials as the valve body or any suitable material, and can include additional materials, such as films, foil, elastomeric materials (e.g. stopper, septum), etc. In the embodiment described below, these modifications entail a multi-component sub-assembly, which can be more or less than three components depending on additional flow valve mechanism.

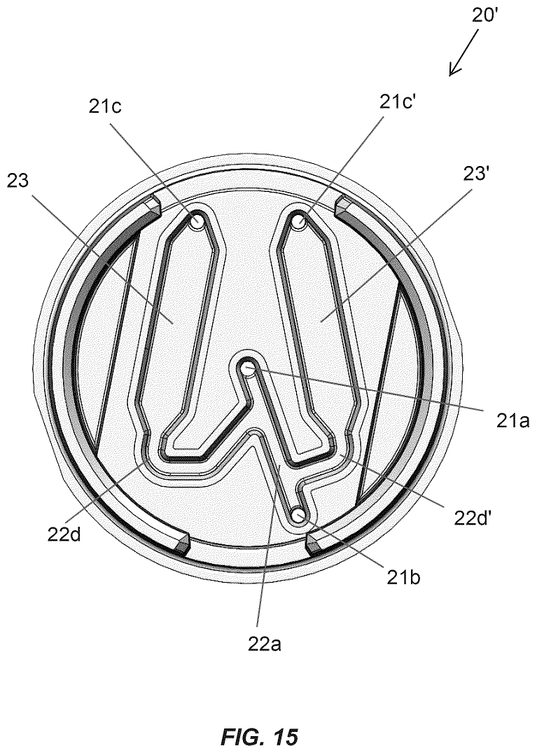

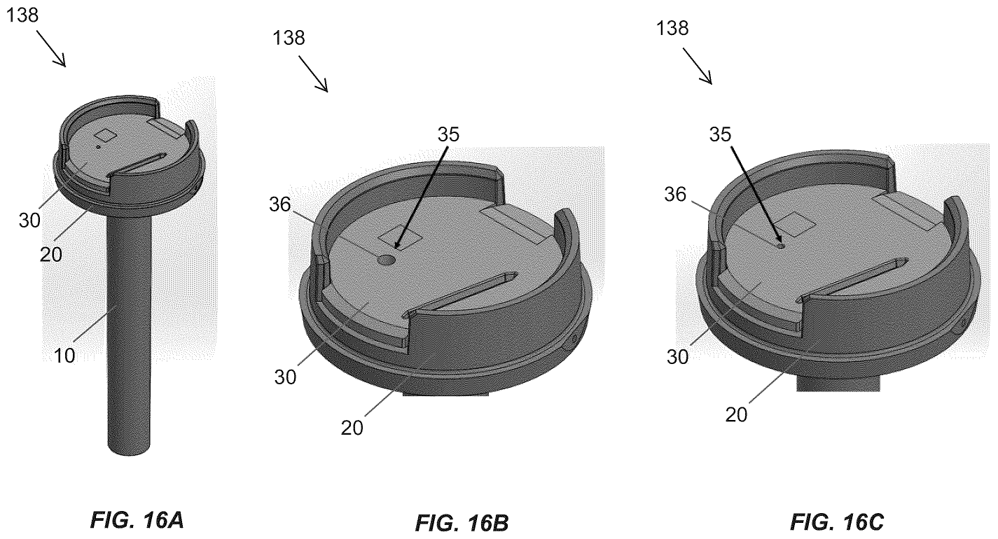

FIGS. 16A-16B show an eighth variation of an integrated valve body syringe tube 138, in accordance with some embodiments. In this eighth variation, the integrated valve body syringe tube 138 includes same or similar features as those noted in previously embodiments, such as those in FIGS. 10A-10D, which includes integrated syringe tube 10 and valve body 20 and cap 30. However, in this embodiment, the valve body can further include a channel and/or cavity that includes a flow valve 35 therein at external port 36 so that fluid can flow out of and/or into the valve body. In some embodiments, valve 35 is a one-way valve so as to control output from and/or input into the valve body. In other embodiments, the valve 35 is a two-way valve to control output and input into the valve body as desired. In this embodiment, the valve as well as the exit port 36 are included in the cap 30. It is appreciated that in other embodiments, the valve and exit port could be located elsewhere or be integrated within the valve body.

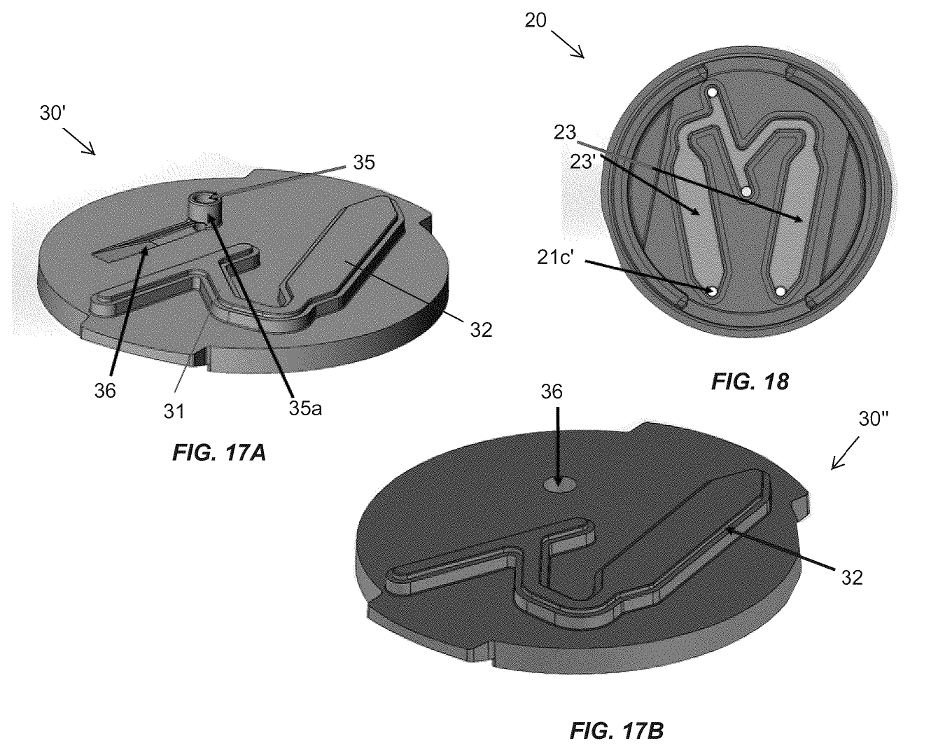

FIGS. 17A-17B show specialized caps 30′, 30″, each configured for use with a valve body having two filter cavities, such as that in FIG. 18, which shows a valve body 20 with offset filter cavity 23 and an additional offset filter cavity 23′ having an additional outlet port 21c′. As shown in FIG. 17A, cap 30′ includes filter cavity protrusions 32 and channel protrusions 31 that together with valve body 20 defined the filter cavity and channels. In this embodiment, the cap further includes valve 35 that includes a valve body 35a that protrudes into a channel or cavity of the valve body. In this embodiment, the valve body 35a protrudes into the second filter cavity 23′ when interfaced with the valve body 20. FIG. 17B shows another cap 30″ having external port 36, which can receive a valve 35, either separately or a valve incorporated into the valve body. In the embodiment of FIG. 17A, the valve includes a movable stopper that selectively moves between an open position and a closed position by insertion of an external component into port 36. It is appreciated that in other embodiments, the valve could include films, such as deformable or penetrable films, septums, mechanically or electrically activated components or any suitable type of valve mechanism.

FIGS. 19A-19B and 20A-20B show additional details of the assembly using the stopper-type valve in the open and closed positions. FIGS. 19A and 19B show a perspective view and a cross-sectional view, respectively, of a valve assembly of a valve body 20 and cap 30 having a stopper-type valve 35 in the closed position. The valve 35 includes the valve body housing 35a and an elastomeric stopper 35b. The stopper can be secured by a friction-fit or biasing member (e.g. spring) or any suitable means. In this embodiment, a fluid channel 31 extends to the second filter cavity 23′ in which the valve 35 is disposed. In this closed position, the stopper blocks any fluid flow through the external port 36, such that the valve body can operate as in described in previous embodiments without any valve or external underside port. FIGS. 20A and 20B show a perspective view and a cross-sectional view, respectively, of a valve assembly of the valve body 20 and cap 30 where the stopper-type valve 35 is in the open position. This transition can be actuated by use of an external component, such as an interface 40 of the module or another external device that is inserted into the external port 36 (see dotted arrow) and which moves the stopper 35b downward so that fluid can flow from or into the channel. In this embodiment, the external component interface 40 includes a male Luer type connector 45 that is inserted into the female Luer type external port 36. It is appreciated that various other types or standards of connectors could be used. Such a configuration can be used to extract fluid from the cavity (see dashed arrows indicating fluid flow through the channel and out the outlet port) and/or channel, and/or to input fluid, such as reagents or other processing agents, into the fluid channel or cavity.

In the foregoing specification, the invention is described with reference to specific embodiments thereof, but those skilled in the art will recognize that the invention is not limited thereto. It is further appreciated that the embodiments described herein can include additional features such as any of those described in U.S. Provisional Application No. 63/626,351 filed Jan. 29, 2024, which is incorporated herein by reference. Various features, embodiments and aspects of the above-described invention can be used individually or jointly. Further, the invention can be utilized in any number of applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art. Unless stated otherwise, the term “about” is considered to mean within +/−10%. It is further appreciated that the various listings and groups of species can be incorporated into an open group (e.g. “comprising”) of species or within a closed group (e.g. “consisting”) of species in the recited combination or any combination thereof. Any references to publication, patents, or patent applications are incorporated herein by reference in their entirety for all purposes.

What is claimed is:

1. A component to facilitate fluid processing in an assay cartridge having multiple processing chambers, the component comprising:
a syringe tube having an upper opening and a conduit extending therethrough to a distal plunger port;
a valve body having a generally circular shape that is coupled to a distal end of the syringe tube and in fluid communication with the plunger port, wherein the valve body further comprises:
a filter cavity that is elongated and configured to receive a filter therein;
one or more flow paths in fluid communication with the filter cavity and the plunger port;
a direct port extending from the one or more fluid flow paths to an upper side of the valve body;
a filter port extending from one end of the filter cavity to an upper side of the valve body;
wherein the syringe tube and the valve body are integrally formed.

2. The component of claim 1, wherein the syringe tube and valve body are formed of polycarbonate, Copolyester or polypropylene.

3. The component of claim 1, wherein the filter cavity and the one or more fluid flow paths between the plunger port and the direct flow port and the filter port are disposed in a common horizontal plane.

4. The component of claim 1, wherein the filter cavity is disposed off-center such that the one or more flow paths direct fluid from the plunger port and into an end of the filter cavity opposite the filter port.

5. The component of claim 1, wherein the one or more flow paths comprise:
a direct flow path extending between the plunger port and the direct port; and
a filter flow path extending between the plunger port and the filter cavity.

6. The component of claim 5 wherein the filter flow path includes a plurality of segments at differing angles and/or curves to inhibit carryover or contamination and improve fluid flow between the direct path and the filter flow path.

7. The component of claim 6 wherein the filter flow path includes:
a first segment angled at an acute angled from the direct path; and
a second segment extending from the first segment that is angled and/or curved further toward the filter cavity.

8. The component of claim 7 wherein the filter flow path includes:
a third segment extending from the second segment that angles or curves at an angle of about 90 degrees or greater and extends to the filter cavity.

9. The component of claim 8, wherein the filter cavity and the one or more fluid flow paths between the plunger port and the direct flow port and the filter port are disposed in a common horizontal plane.

10. The component of claim 5, wherein the direct flow path is disposed within the valve body or in a gasket overmolded within the valve body.

11. The component of claim 1, further comprising:
a cap that is shaped to be fittingly received on an underside of the valve body so as to seal the filter cavity and the one or more fluid flow paths.

12. The component of claim 11, wherein the cap includes a filter cavity protrusion contoured to be received within and enclose the filter cavity.

13. The component of claim 12, wherein the cap further includes one or more flow path protrusions that are contoured to be received within and enclose the one or more flow paths.

14. The component of claim 11, wherein the cap is sealingly coupled to the underside of the valve body by a weld.

15. The component of claim 14, wherein the weld is an ultrasonic shear weld and the valve body and/or cap includes one or more weld ridges to facilitate welding.

16. The component of claim 15, wherein the weld is any of: an ultrasonic shear weld, an ultrasonic butt weld, and a laser weld lap joint.

17. The component of claim 11, wherein the cap is sealingly coupled to the underside of the valve body by a snap-fit coupling.

18. The component of claim 11, further comprising a gasket disposed on a cap-side.

19. The component of claim 11, further comprising a gasket disposed on a valve body-side.

20. The component of claim 11, comprising a gasket that is an overmold formed by being injection molded into the valve body.

21. The component of claim 1, wherein an underside of the valve body is sealed by a thin film.

22. The component of claim 21, wherein the thin film is sealed by heat sealing or adhesive.

23. The component of claim 1, further comprising:
a gasket coupled with the integrated valve body and syringe tube component and configured to facilitate sealing of any of the filter chamber, the one or more fluid flow paths, and the fluid ports.

24. The component of claim 1, wherein the component seals without use of any gasket.

25. The component of claim 11, wherein the filter cavity is offset from center and the valve body includes an additional filter cavity offset from center.

26. The component of claim 25, wherein the additional filter cavity is fluidically connected to the direct path at one end and includes an additional outlet port at or near an opposite end.

27. The component of claim 25 wherein the cap includes additional protrusions that correspond to the additional filter cavity and any additional flow channels associated therewith.

28. The component of claim 25 wherein the cap further includes one or more valves.

29. The component of claim 28 wherein the one or more valves includes a one-way valve.

30. The component of claim 29 wherein the one-way valve includes a valve housing that protrudes into the additional filter cavity and includes a corresponding flowpath and a movable stopper that moves between an open position allow fluid flow into and/or out from the additional filter cavity and a closed position that seals the additional filter cavity.
